(19) United States
(12) Patent Application Publication
(10) Pub. No.: US 2026/0044890 A1
(43) Pub. Date: Feb. 12, 2026

(54) METAVERSE-BASED LUXURY ITEM EXPERIENCING SYSTEM AND METHOD

(71) Applicant: Boying ZHAO, Seoul (KR)

(72) Inventor: Boying ZHAO, Seoul (KR)

(21) Appl. No.: 19/104,238

(22) PCT Filed: Oct. 7, 2022
(86) PCT No.: PCT/KR2022/015146

§ 371 Date: Feb. 17, 2025

(30) Foreign Application Priority Data
Aug. 25, 2022 (KR) 10-2022-0106597

(51) Int. Cl. G06Q 30/0601

(52) U.S. Cl. CPC G06Q 30/06432

(57) ABSTRACT

A metaverse-based luxury experience system and method are disclosed. The system includes a luxury 3D scanner that scans the shape of luxury items and a metaverse platform server that implements a virtual environment to display and sell 3D luxury items. The server enables a 3D user avatar to wear or experience these items using metaverse interface goggles and gloves. Additionally, users can scan themselves to create proportionate 3D avatars, ensuring accurate representation of luxury items. This allows users to virtually try on luxury items, assess fit, and make purchase decisions without physically wearing them.

### BACKGROUND OF THE INVENTION

### Field of the Invention

The present disclosure relates to a luxury experience system and method, and more specifically, to a metaverse-based luxury experience system and method.

### Description of Related Art

Recently, demand for luxury items has been strong even among young people.

Numerous luxury products such as clothing, shoes, watches, jewelry, and bags are constantly releasing, but it is virtually impossible for a user to try on all of these luxury goods to see which ones suit him or her.

A consumer group in their 20s does not have any aversion to games, virtual reality, or metaverse, and rather feels more familiar with the same.

In order to rapidly and easily feel the fit of luxury items, it can be very efficient to experience the luxury items through virtual reality or a metaverse.

However, the luxury experience area is still limited to offline, and it is difficult to experience luxury goods easily.

It is necessary to find ways to expand the luxury experience area in a metaverse to meet the demand for luxury items experience and to further increase the demand for luxury goods.

However, there are limits to increasing the realism of the experience through only 2D simulation.

### SUMMARY OF THE INVENTION

An object of the present disclosure is to provide a metaverse-based luxury experience system.

Another object of the present disclosure is to provide a metaverse-based luxury experience method.

In an aspect, a metaverse-based luxury experience system includes a luxury 3D scanner device configured to 3D scan a shape of a luxury item, and a metaverse platform server configured to implement a metaverse and display and sell 3D luxury items according to 3D scanning results of the luxury 3D scanner device in a metaverse luxury store.

Here, the metaverse platform server may be configured to perform a simulation such that a 3D user avatar wears or experiences the 3D luxury items displayed and sold according to interfacing of goggles for a metaverse interface and gloves for the metaverse interface.

In another aspect, a metaverse-based luxury experience method includes 3D scanning a shape of a luxury item by a luxury 3D scanner device, implementing a metaverse luxury store in a metaverse by a metaverse platform server, and displaying and selling, by the metaverse platform server, 3D luxury items according to 3D scanning results of the luxury 3D scanner device in the implemented metaverse luxury store.

Here, the metaverse-based luxury experience method may further include performing, by the metaverse platform server, a simulation such that a 3D user avatar wears or experiences the 3D luxury items displayed and sold according to interfacing of goggles for a metaverse interface and gloves for the metaverse interface.

According to the above-described metaverse-based luxury experience system and method, not only luxury goods but also a user can use a 3D scanner to 3D scan them and measure their actual sizes to create a 3D user avatar and 3D luxury items of the same proportions, thereby enabling luxury experience in a metaverse. As a result, even if the user does not wear actual luxury items, the user can check the fit by having their avatar wear the luxury items in the metaverse, and rapidly decide whether to purchase the luxury items.

In particular, by directly selling 3D luxury items to 3D user avatars in a metaverse luxury store and issuing the 3D luxury items as NFT luxury items, 3D user avatars can wear their own luxury items and be active in the metaverse.

In addition, when another 3D user avatar wears an NFT luxury item owned by a 3D user avatar of a user, the NFT luxury item is marked as a stolen item or a lost item, thereby preventing others from wearing the user's NFT luxury item in a metaverse and preventing loss of assets in the metaverse.

Furthermore, a 3D user avatar can lend their NFT luxury items to others, thereby generating revenue through lending.

When a 3D user avatar loses their NFT luxury item, they can check location information, and thus can find their NFT luxury item in the metaverse.

### BRIEF DESCRIPTION OF DRAWINGS

FIG. 1 is a block diagram of a metaverse-based luxury experience system according to an embodiment of the present disclosure.

FIG. 2 is a flow chart of a metaverse-based luxury experience method according to an embodiment of the present disclosure.

### DETAILED DESCRIPTION OF THE INVENTION

Reference will now be made in detail to embodiments, examples of which are illustrated in the accompanying drawings. While the disclosure is susceptible to various modifications and alternative forms, specific embodiments thereof are shown by way of example in the drawings. However, the disclosure should not be construed as limited to the embodiments set forth herein, but on the contrary, the disclosure is to cover all modifications, equivalents, and alternatives falling within the spirit and scope of the embodiments.

Reference will now be made in detail to embodiments, examples of which are illustrated in the accompanying drawings. While the disclosure is susceptible to various modifications and alternative forms, specific embodiments thereof are shown by way of example in the drawings. However, the disclosure should not be construed as limited to the embodiments set forth herein, but on the contrary, the disclosure is to cover all modifications, equivalents, and alternatives falling within the spirit and scope of the embodiments.

While terms, such as “first”, “second”, “A”, and “B” may be used to describe various components, such components must not be limited by the above terms. The above terms are used only to distinguish one component from another. For example, without departing from the scope of the present disclosure, the first component may be referred to as the second component, and similarly, the second component may also be referred to as the first component. The term “and/or” includes any combination of a plurality of related described items or any item among a plurality of related described items.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The terms used in the present disclosure are merely used in order to describe particular embodiments, and are not intended to limit the present disclosure. An element described in the singular form is intended to include a plurality of elements unless the context clearly indicates otherwise. In the present disclosure, it will be further understood that the terms “comprise” and “includes” specify the presence of stated features, integers, steps, operations, elements, components, and/or combinations thereof, but do not preclude the presence or addition of one or more other features, integers, steps, operations, elements, components, and/or combinations.

Unless otherwise defined, all terms including technical and scientific terms used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Hereinafter, a preferred embodiment according to the present disclosure will be described in detail with reference to the attached drawings.

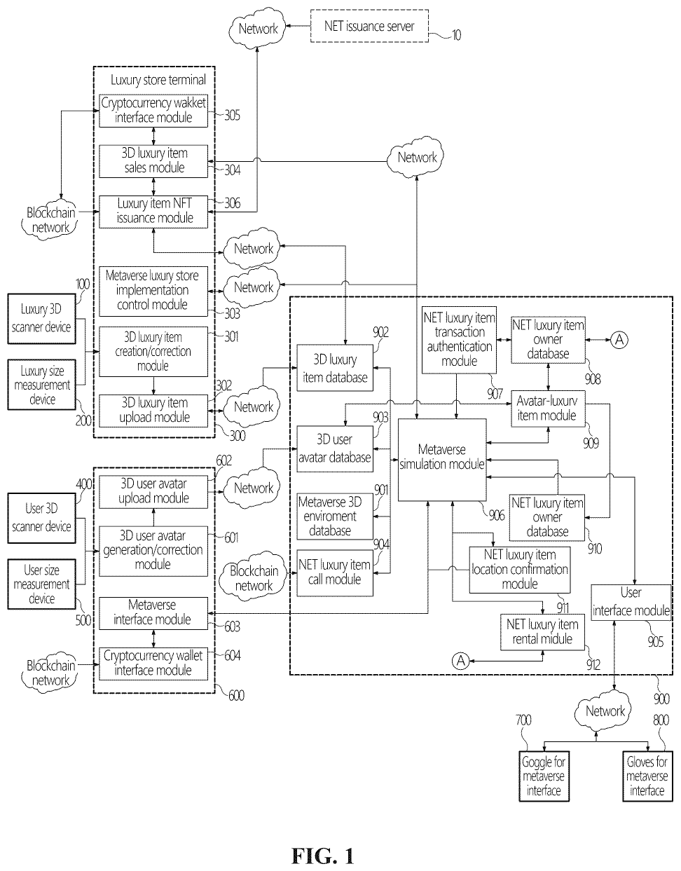

FIG. 1 is a block diagram of a metaverse-based luxury experience system according to an embodiment of the present disclosure.

Referring to FIG. 1, the metaverse-based luxury experience system according to an embodiment of the present disclosure may include a luxury 3D scanner device 100, a luxury size measurement device 200, a luxury store terminal 300, a user 3D scanner device 400, a user size measurement device 500, a user terminal 600, goggles 700 for a metaverse interface, gloves 800 for a metaverse interface, and a metaverse platform server 900.

Hereinafter, the detailed configuration will be described.

The luxury 3D scanner device 100 may 3D scan the shape of a luxury item. Here, luxury items include clothing, shoes, watches, jewelry, bags, cosmetics, cars, bicycles, etc., and there is no limitation.

The luxury size measurement device 200 may be configured to measure the size of a luxury item.

The luxury store terminal 300 may be configured to create a 3D luxury item using a 3D scanning result of the luxury 3D scanner device 100 and an actual measurement result of the luxury size measurement device 200.

The luxury store terminal 300 may include a 3D luxury item creation/correction module 301, a 3D luxury item upload module 302, a metaverse luxury store implementation control module 303, a 3D luxury item sales module 304, a cryptocurrency wallet interface module 305, and a luxury item NFT issuance module 306.

Hereinafter, the detailed configuration will be described.

The 3D luxury item creation/correction module 301 may be configured to create and correct a 3D luxury item using a 3D scanning result of the luxury 3D scanner device 100 and an actual measurement result of the luxury size measurement device 200.

The 3D luxury item upload module 302 may be configured to upload a 3D luxury item created and corrected by the 3D luxury item creation/correction module 301 to the metaverse platform server 900.

The metaverse luxury store implementation control module 303 may be configured to implement a metaverse luxury store in the metaverse implemented by the metaverse platform server 900 and control display and sale of 3D luxury items.

In the metaverse luxury store, a user can experience real luxury items in the metaverse, and 3D luxury items can be sold as luxury items for 3D user avatars to wear and use in the metaverse.

In the metaverse luxury store, an environment in which a 3D user avatar can wear a 3D luxury item and check the same through a mirror from the perspective of the 3D user avatar may be constructed.

The 3D luxury item sales module 304 may be configured to sell a 3D luxury item to a 3D user avatar in the metaverse.

The cryptocurrency wallet interface module 305 may be configured to receive a sales price of a 3D luxury item sold by the 3D luxury item sales module 304 in cryptocurrency from the user terminal 600 and check the same in real time.

The luxury item NFT issuance module 306 may be configured to issue an NFT luxury item through an NFT issuance server 10 for a 3D luxury item sold by the 3D luxury item sales module 304.

The luxury item NFT issuance module 306 may be configured to store the issued NFT luxury item on a blockchain and provide the address of the blockchain to the corresponding user terminal 600.

The user 3D scanner device 400 may be configured to 3D scan the shape of a user.

The user size measurement device 500 may be configured to measure the size of the user.

The user terminal 600 may be configured to generate a 3D user avatar using a 3D scanning result of the user 3D scanner device 400 and a measurement result of the user size measurement device 500.

The user terminal 600 may include a 3D user avatar generation/correction module 601, a 3D user avatar upload module 602, a metaverse interface module 603, and a cryptocurrency wallet interface module 604.

The detailed configuration will be described below.

The 3D user avatar creation/correction module 601 may be configured to create and correct a 3D user avatar using a 3D scanning result of the user 3D scanner device 400 and an actual measurement result of the user size measurement device 500. The 3D user avatar may be created to be nearly identical to the user's face and body shape.

The 3D user avatar upload module 602 may be configured to upload the 3D user avatar created and corrected by the 3D user avatar creation/correction module 601 to the metaverse platform server 900.

Here, a 3D user avatar or a 3D luxury item may be implemented in the metaverse at the same proportion, and the size proportions of the 3D user avatar and the 3D luxury item may be the same as the size proportions in the real world. Accordingly, a user can experience the fit in the real world.

The metaverse interface module 603 may be configured to transmit an NFT luxury item call input of a user, a luxury item location confirmation input, or a luxury item rental input to the metaverse platform server 900.

Here, the NFT luxury item call input is a command for calling a personally owned NFT luxury item stored on the blockchain as it is and simulating the same in the metaverse such that the NFT luxury item exists only in the metaverse.

The NFT luxury item location confirmation input is a command for checking where the NFT luxury item exists in the metaverse.

The NFT luxury item rental input is a command for renting the NFT luxury item to another 3D user avatar.

The cryptocurrency wallet interface module 604 may be configured to transmit a purchase price of a 3D luxury item sold by the 3D luxury item sales module 304 of the luxury store terminal 300 in cryptocurrency to the luxury store terminal 300. Here, actual transaction may be made by sending/receiving cryptocurrency between the luxury store terminal 300 and the user terminal 600.

The goggles 700 for a metaverse interface may be configured to be worn by the user for the interface of the 3D user avatar in the metaverse. The user may view and check the metaverse through the goggles 700 for the metaverse interface, and input various commands through the goggles 700.

The gloves 800 for the metaverse interface may be configured to be worn by the user for the interface of the 3D user avatar in the metaverse. The user may select and wear a 3D luxury item while wearing the gloves 800 for the metaverse interface and may issue various commands, such as purchasing a 3D luxury item or renting an NFT luxury item owned by the user.

Here, a fingerprint recognition module (not shown) may be built into the gloves 800 for the metaverse interface, and the fingerprint recognition module (not shown) may be configured to confirm whether the user wearing the gloves 800 for the metaverse interface is the user of the corresponding 3D user avatar through fingerprint recognition. The user's fingerprint may be stored in advance in a user fingerprint database (not shown) of the metaverse platform server 900.

In addition to the goggles 700 for the metaverse interface and the gloves 800 for the metaverse interface, the user may wear additional components such as a microphone (not shown) and a headset (not shown) for voice conversation with other 3D user avatars.

In addition, the user may have a text conversation with other 3D user avatars using the user terminal 600.

A user identification module (not shown) of the metaverse platform server 900 may be configured to receive a fingerprint recognized by the fingerprint recognition module (not shown), compare the fingerprint with matching data of the user and the 3D user avatar stored in advance in the user fingerprint database (not shown), and restrict a specific action of the 3D user avatar if it is determined that the received fingerprint is not the fingerprint of the user. For example, if the 3D user avatar attempts to perform an action of wearing an NFT luxury item, an action of renting an NFT luxury item, or an action of purchasing a 3D luxury item, the user identification module may permit or restrict the action.

When the 3D user avatar attempts to perform an action of wearing an NFT luxury item, an action of renting an NFT luxury item, or an action of purchasing a 3D luxury item, the user identification module (not shown) may request fingerprint recognition by the fingerprint recognition module (not shown) and perform a user identification process using the fingerprint recognition result. Then, the user identification module (not shown) may permit an action of wearing an NFT luxury item, an action of renting an NFT luxury item, or an action of purchasing a 3D luxury item upon determining that the 3D user avatar matches the user, and restrict an action of wearing an NFT luxury item, an action of renting an NFT luxury item, or an action of purchasing a 3D luxury item upon determining that the 3D user avatar does not match the user.

The metaverse platform server 900 is a component for implementing a metaverse, and the metaverse may be implemented like the real world and may be configured to build a space where 3D user avatars can live, shop, watch movies, go to parks, go to work or school, and meet or play with other 3D user avatars.

The metaverse platform server 900 may be configured to implement a metaverse luxury store in the metaverse. The interior of such a metaverse luxury store may be individually implemented by the metaverse luxury store implementation control module 303 of the luxury store terminal 300, and items, number, and display method of 3D luxury goods may be determined.

The metaverse platform server 900 may be configured to display and sell 3D luxury items created by the luxury store terminal 300 in a luxury store in the metaverse.

The metaverse platform server 900 may be configured to perform a simulation such that a 3D user avatar created by the user terminal 600 wears or experiences a 3D luxury item displayed and sold according to interfacing of the metaverse interface goggles 700 and the metaverse interface gloves 800.

The metaverse platform server 900 may include a metaverse 3D environment database 901, a 3D luxury item database 902, a 3D user avatar database 903, an NFT luxury item call module 904, a user interface module 905, a metaverse simulation module 906, an NFT luxury item transaction authentication module 907, an NFT luxury item owner database 908, an avatar-luxury item matching confirmation module 909, an NFT luxury item display control module 910, an NFT luxury item location confirmation module 911, and an NFT luxury item rental module 912.

The detailed configuration will be described below.

The metaverse 3D environment database 901 may be configured to store 3D environment information for constructing a metaverse.

The 3D luxury item database 902 may be configured to store 3D luxury items uploaded by the 3D luxury item upload module 302 of the luxury store terminal 300.

The 3D user avatar database 903 may be configured to store a 3D user avatar uploaded by the 3D user avatar upload module 602 of the user terminal 600.

The NFT luxury item call module 904 may be configured to call an NFT luxury item issued by the luxury item NFT issuance module 306 on the blockchain such that the NFT luxury item can be simulated in the metaverse according to an NFT luxury item call input received from the metaverse interface module 603 of the user terminal 600.

The user interface module 905 may be configured to communicate with the metaverse interface goggles 700 and the metaverse interface gloves 800 for interfacing of the 3D user avatar in the metaverse.

The metaverse simulation module 906 may be configured to construct the metaverse with reference to the metaverse 3D environment database 901.

Here, the metaverse simulation module 906 may implement a metaverse luxury store in the metaverse by the metaverse luxury store implementation control module 303.

The metaverse simulation module 906 may be configured to display and sell 3D luxury items in the 3D luxury item database 902 in a metaverse luxury store by the control of the metaverse luxury store implementation control module 303.

The metaverse simulation module 906 may be configured to implement a 3D user avatar in the 3D user avatar database 903 in the metaverse such that the 3D user avatar performs an interface in the metaverse by the user interface module 905.

The metaverse simulation module 906 may be configured to simulate an NFT luxury item called on the blockchain by the NFT luxury item call module 904 in the metaverse. Here, the NFT luxury item may be configured to exist only in the current metaverse. That is, when the NFT luxury item is called on the blockchain, the call record may be left on the blockchain and transaction may not be made in the offline real world or another metaverse other than the called metaverse.

The NFT luxury item transaction authentication module 907 may be configured to issue a 3D luxury item as an NFT luxury item when the 3D luxury item is sold in the metaverse by the metaverse simulation module 906, and perform transaction authentication for the corresponding luxury store terminal 300 and the corresponding user terminal 600.

The NFT luxury item owner database 908 may be configured to store NFT luxury items for which transaction authentication has been performed by the NFT luxury item transaction authentication module 907 and the owners of the NFT luxury items in such a manner that the NFT luxury items match the owners.

The avatar-luxury item matching confirmation module 909 may be configured to, when a certain 3D user avatar wears a certain NFT luxury item in the metaverse, match the NFT luxury item with the 3D user avatar by referring to the NFT luxury item owner database 908 and check in real time whether the 3D user avatar is the owner.

The NFT luxury item display control module 910 may be configured to control the NFT luxury item to be displayed as a stolen item or a lost item if the 3D user avatar is not the owner of the NFT luxury item as a result of matching of the avatar-luxury item matching confirmation module 909.

That is, if the 3D user avatar is the owner of the NFT luxury item as a result of the matching, the NFT luxury item may be displayed while maintaining its normal color and shape in a worn state, but if the 3D user avatar is not the owner of the NFT luxury item as a result of the matching, the NFT luxury item may be displayed only with a colorless shape line or may be indicated as a stolen or lost item by displaying a warning light. As a result, when an NFT luxury item is lost or stolen, others cannot use this NFT luxury item normally in the metaverse.

The NFT luxury item location confirmation module 911 may be configured to check the location of an NFT luxury item owned by the corresponding 3D user avatar in the metaverse in real time according to an NFT luxury item location confirmation input received from the metaverse interface module 603 of the user terminal 600. If the NFT luxury item is lost, it can be easily found.

The NFT luxury item rental module 912 may be configured to rent an NFT luxury item owned by the corresponding 3D user avatar to another 3D user avatar in the metaverse according to an NFT luxury item rental input received from the metaverse interface module 603 of the user terminal 600. Through such rental, the user can generate revenue while not accessing the metaverse.

Here, if the corresponding 3D user avatar wears the corresponding NFT luxury item by renting the same through the NFT luxury item rental module 912, the NFT luxury item display control module 910 may perform control such that the NFT luxury item is displayed as an item that is not a stolen item or a lost item.

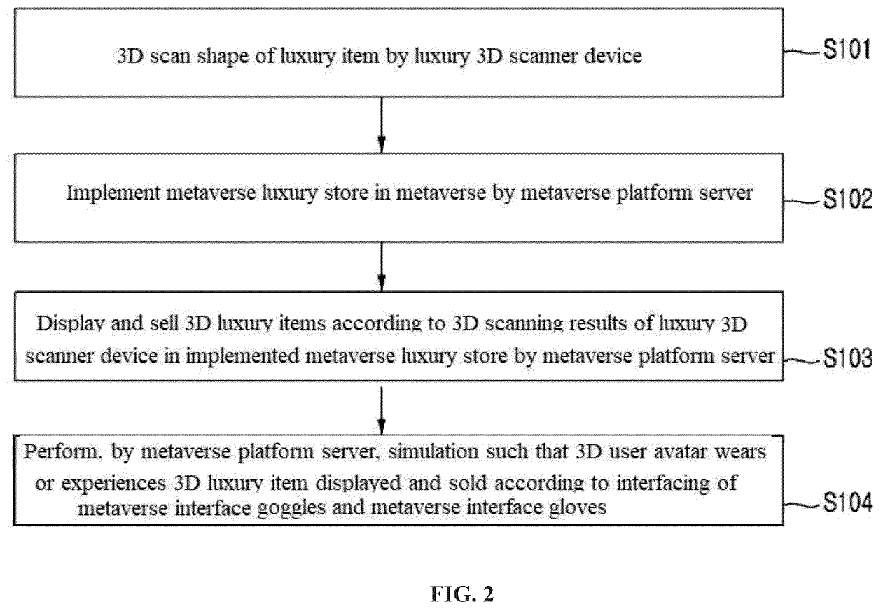

FIG. 2 is a flowchart of a luxury experience method based on a metaverse according to an embodiment of the present disclosure.

Referring to FIG. 2, the luxury 3D scanner device 100 3D scans the shape of a luxury item (S101).

Next, the metaverse platform server 900 implements a metaverse luxury store in a metaverse (S102).

Next, the metaverse platform server 900 displays and sells 3D luxury items based on 3D scanning results of the luxury 3D scanner device 100 in the implemented metaverse luxury store (S103).

Next, the metaverse platform server 900 performs a simulation such that a 3D user avatar wears or experiences 3D luxury items displayed and sold according to interfacing of the metaverse interface goggles 700 and the metaverse interface gloves 800 (S104).

Although the present disclosure has been described with reference to the above embodiment, it will be understood that those skilled in the art can modify and change the present disclosure in various manners without departing from the spirit and scope of the present disclosure described in the following claims.

The present disclosure can be widely used in industries related to Internet shopping malls, game-related industries, virtual reality experience service-related industries, etc.

What is claimed is:

1. A metaverse-based luxury experience system comprising:
a luxury 3D scanner device configured to 3D scan a shape of a luxury item; and
a metaverse platform server configured to implement a metaverse and display and sell 3D luxury items according to 3D scanning results of the luxury 3D scanner device in a metaverse luxury store.

2. The metaverse-based luxury experience system of claim 1, wherein the metaverse platform server performs a simulation such that a 3D user avatar wears or experiences the 3D luxury items displayed and sold according to interfacing of goggles for a metaverse interface and gloves for the metaverse interface.

3. A metaverse-based luxury experience method comprising:
3D scanning a shape of a luxury item by a luxury 3D scanner device; implementing a metaverse luxury store in a metaverse by a metaverse platform server; and
displaying and selling, by the metaverse platform server, 3D luxury items according to 3D scanning results of the luxury 3D scanner device in the implemented metaverse luxury store.

4. The metaverse-based luxury experience method of claim 3, further comprising performing, by the metaverse platform server, a simulation such that a 3D user avatar wears or experiences the 3D luxury items displayed and sold according to interfacing of goggles for a metaverse interface and gloves for the metaverse interface.
